(19) United States
(12) Patent Application Publication
(10) Pub. No.: US 2009/0279478 A1
(43) Pub. Date: Nov. 12, 2009

(54) METHOD AND APPARATUS FOR FACILITATING DYNAMIC COOPERATIVE INTERFERENCE REDUCTION

(75) Inventors: Shirish Nagaraj, Hoffman Estates, IL (US); Philip J. Fleming, Glen Ellyn, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/126,133

(22) Filed: May 23, 2008

Related U.S. Application Data
(60) Provisional application No. 61/050,768, filed on May 6, 2008.

(51) Int. Cl. H04Q 7/00

(52) U.S. Cl. 370/328

(57) ABSTRACT

Various embodiments are described for potentially improving coverage and/or the cell-edge outage rate and thereby the system capacity. Logic flow diagrams 10 and 20, in FIGS. 1 and 2, depict functionality performed by communication devices in the system. A first communication device, attempting to successfully receive (12) signaling from a source communication device, transmits (14) signaling indicating that it is requesting an interfering communication device to reduce transmissions that may be interfering with signaling from the source communication device. In response to this signaling from the first communication device (22), the interfering communication device reduces (24) transmissions based at least in part on what was indicated by the signaling from the first communication device. Thus, cooperative interference reduction may be achieved dynamically by receiving devices signaling other devices in the system to request interference relief when needed.

### REFERENCE(S) TO RELATED APPLICATION(S)

The present application claims priority from a provisional application Ser. No. 61/050,768, entitled “METHOD AND APPARATUS FOR FACILITATING DYNAMIC COOPERATIVE INTERFERENCE REDUCTION,” filed May 6, 2008, which is commonly owned and incorporated herein by reference in its entirety.

### FIELD OF THE INVENTION

The present invention relates generally to wireless communication and, in particular, to facilitating dynamic cooperative interference reduction in wireless communication systems.

### BACKGROUND OF THE INVENTION

In evolving 4G wireless systems such as 3GPP LTE (Long Term Evolution), IEEE 802.16m and 3GPP2 UMB (Ultra Mobile Broadband), one of the key focuses is on providing superior quality VoIP service as well as high network capacity for such services. Another focus is on providing a good edge-of-cell data rate while not significantly impacting the overall sector rate. The nature of latency-sensitive traffic (VoIP-like traffic) is that capacity is primarily determined by the air-interface delay outage. Improving the post-HARQ error rate with a minimal increase in system resources (such as power, bandwidth allocation and/or amount of feedback) can provide significant improvements in coverage and outage rate, and thus, has the potential to improve capacity for these applications. Coverage improvements, even for other classes of traffic, are highly desirable in these evolving networks as are techniques for improving the cell-edge outage rate with minimal additional signaling requirements.

Some outage and coverage improvements involve semi-static partitioning of resources using fractional frequency reuse (FFR) and are described in the UMB and LTE standards. However, these methods can be wasteful since, in a given cell, the fraction of outage users can be different than what the FFR deployment targeted. Other methods to increase cell-edge rates involve interference cancellation (e.g., IDMA), but these come with the need for complex interference cancellation receivers to be implemented in the mobiles (see e.g., R1-050608, “Inter-cell Interference Mitigation based on IDMA,” RITT, 3GPP TSG RAN WG1 Ad Hoc on LTE, Sophia Antipolis, France, 20-21 Jun., 2005). Thus, new techniques able to improve coverage and/or the cell-edge outage rate that are less wasteful and/or less complex would be desirable.

### BRIEF DESCRIPTION OF THE DRAWINGS

FIG. 1 is a logic flow diagram of functionality performed by a communication device in a wireless communication system in accordance with multiple embodiments of the present invention.

FIG. 2 is a logic flow diagram of functionality performed by an interfering communication device in a wireless communication system in accordance with multiple embodiments of the present invention.

FIG. 3 is a block diagram depiction of a wireless communication system in accordance with multiple embodiments of the present invention.

FIG. 4 is a simplified depiction of a wireless communication system for use in illustrating some detailed embodiments of the present invention.

FIG. 5 is a simplified depiction of a wireless communication system for use in illustrating some other detailed embodiments of the present invention.

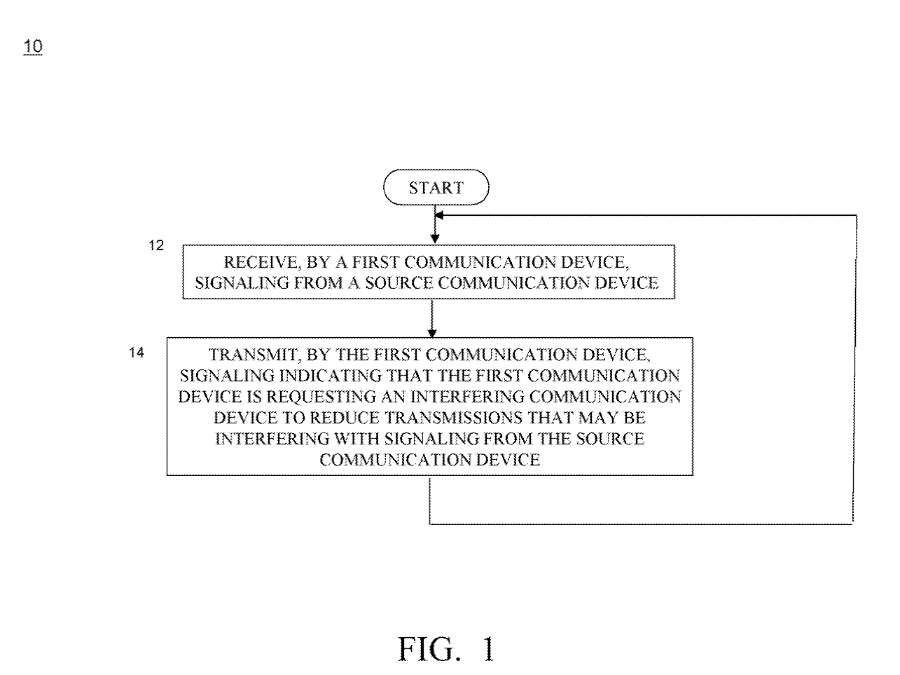

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams and/or the logic flow diagrams above are described and shown with reference to specific signaling exchanged and/or specific functionality performed in a specific order, some of the signaling/functionality may be omitted or some of the signaling/functionality may be combined, sub-divided, or reordered without departing from the scope of the claims. Thus, unless specifically indicated, the order and grouping of the signaling/functionality depicted is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

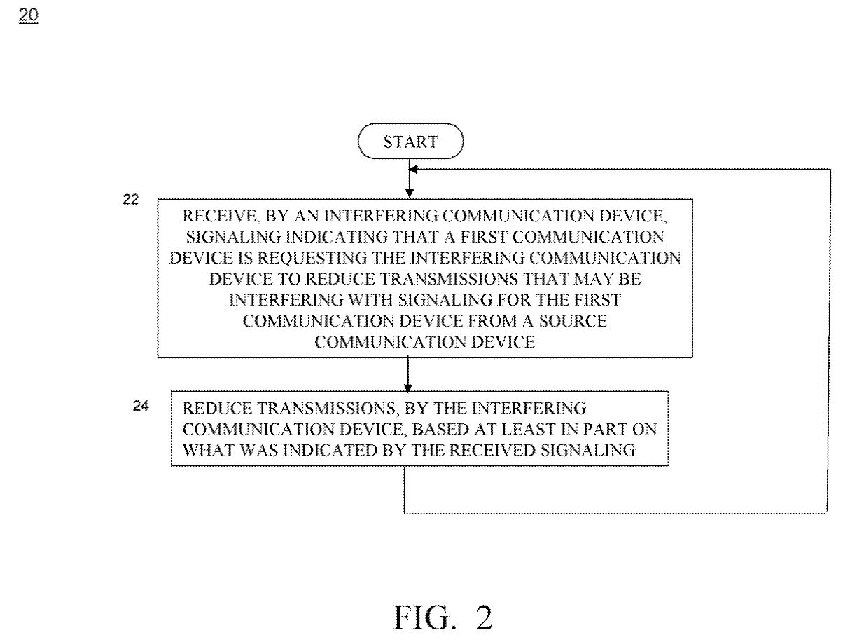

Various embodiments are described for potentially improving coverage and/or the cell-edge outage rate and thereby the system capacity. Logic flow diagrams 10 and 20, in FIGS. 1 and 2, depict functionality performed by communication devices in the system. A first communication device, attempting to successfully receive (12) signaling from a source communication device, transmits (14) signaling indicating that it is requesting an interfering communication device to reduce transmissions that may be interfering with signaling from the source communication device. In response to this signaling from the first communication device (22), the interfering communication device reduces (24) transmissions based at least in part on what was indicated by the signaling from the first communication device. (Note that reducing transmissions may be accomplished by not transmitting, or equivalently, muting the power.) Thus, cooperative interference reduction may be achieved dynamically by receiving devices signaling other devices in the system to request interference relief when needed.

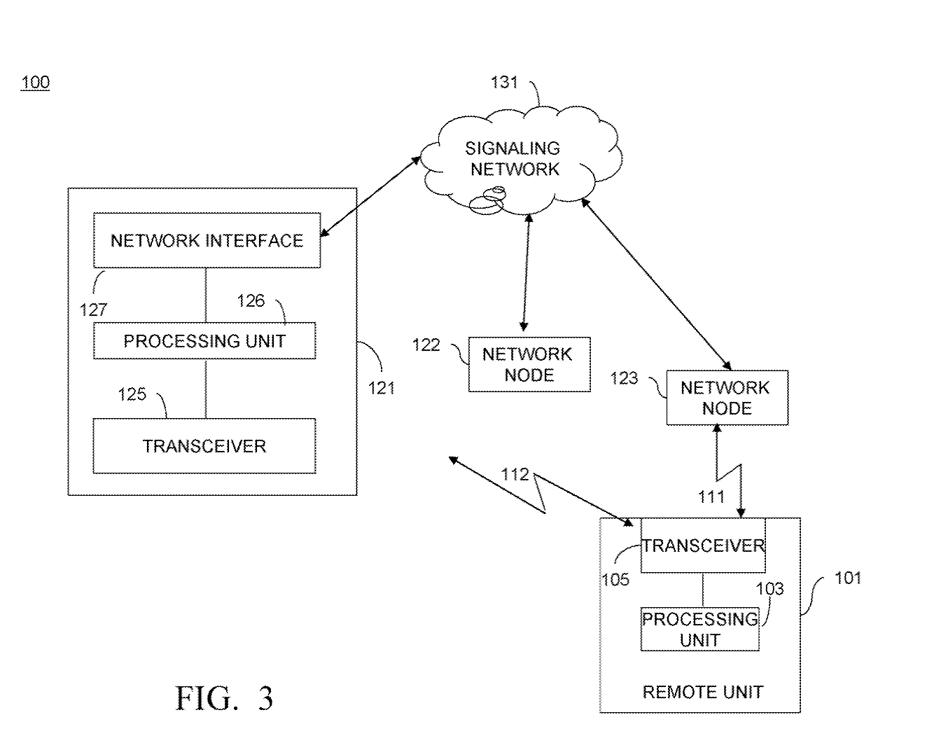

The disclosed embodiments can be more fully understood with reference to FIGS. 3-5. FIG. 3 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/ respectively.) Communication system 100 represents a system having an architecture in accordance with one or more of the 3GPP LTE, 3GPP2 UMB and/or IEEE 802 technologies, suitably modified to implement the present invention. Alternative embodiments of the present invention may be implemented in communication systems that employ other or additional technologies such as, but not limited to, those described in the OMA, WiMAX Forum, 3GPP, and/or 3GPP2 specifications.

Communication system 100 is depicted in a very generalized manner. For example, system 100 is shown to simply include remote unit 101, network nodes 121-123 and signaling network 131. Network nodes 121-123 are shown having interconnectivity via signaling network 131. Network node 123 is shown providing network service to remote unit 101 using wireless interface 111. The wireless interface used is in accordance with the particular access technology supported by network node 123, such as one based on IEEE 802.16. Network nodes 121-123 may all utilize the same wireless access technology, or they may utilize different access technologies. Those skilled in the art will recognize that FIG. 3 does not depict all of the physical fixed network components that may be necessary for system 100 to operate but only those system components and logical entities particularly relevant to the description of embodiments herein.

For example, FIG. 3 does not depict that network nodes 122-123 each comprise processing units, network interfaces and transceivers. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, devices 121-123 represent known devices that have been adapted, in accordance with the description herein, to implement multiple embodiments of the present invention. Furthermore, those skilled in the art will recognize that aspects of the present invention may be implemented in or across various physical components and none are necessarily limited to single platform implementations. For example, a network node may be implemented in or across one or more RAN components, such as a base transceiver station (BTS) and/or a base station controller (BSC), a Node-B and/or a radio network controller (RNC), or an HRPD AN and/or PCF, or implemented in or across one or more access network (AN) components, such as an access service network (ASN) gateway and/or ASN base station (BS), an access point (AP), a wideband base station (WBS), and/or a WLAN (wireless local area network) station.

Remote unit 101 and network node 123 are shown communicating via technology-dependent, wireless interface 111. Remote units, subscriber stations (SSs) and/or user equipment (UEs), may be thought of as mobile stations (MSs), mobile subscriber stations (MSSs), mobile devices or mobile nodes (MNs). In addition, remote unit platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). In particular, remote unit 101 comprises a processing unit (103) and transceiver (105). Depending on the embodiment, remote unit 101 may additionally comprise a keypad (not shown), a speaker (not shown), a microphone (not shown), and a display (not shown). Processing units, transceivers, keypads, speakers, microphones, and displays as used in remote units are all well-known in the art.

Operation of embodiments in accordance with the present invention occurs substantially as follows, first with reference to FIG. 3. As depicted in FIG. 3, network node 123, the current serving node for remote unit 101, is attempting to successfully transmit a packet to remote unit 101. Processing unit 103 receives, via transceiver 105, receive signaling that includes a packet which is not successfully received from network node 123. Depending on the embodiment, processing unit 103 may determine that the transmission/retransmission of the packet is sufficiently near to being aborted that interference relief is desirable. For example, depending on the embodiment, this determination may be made after a threshold number unsuccessful retransmissions, such as HARQ (hybrid automatic retransmission request) retransmissions. For example, this determination may be made after the second-to-last HARQ transmission of the packet.

Processing unit 103 then transmits signaling 112, via transceiver 105, indicating that remote unit 101 is requesting an interfering communication device to reduce transmissions that may be interfering with signaling from network node 123. Depending on the embodiment, signaling 112 may indicate a resource block, a sub-channel, a beam and/or a duration for which reduced transmission is requested. Processing unit 126 receives signaling 112, via transceiver 125, and based at least in part on what was indicated by signaling 112, it reduces transmissions. Again depending on the embodiment, reducing transmissions may involve muting transmit power, reducing transmit power or reducing transmit power spectral density (PSD) for an indicated resource block, for an indicated sub-channel, for an indicated beam and/or for an indicated duration.

In addition to network node 121, network node 122 may also receive signaling 112 and reduce transmissions accordingly. (That is, unless signaling 112 is specifically directed to node 121.) Also, depending on the embodiment, node 121 may not receive signaling 112 via transceiver 125. Rather, another network node, such as node 123, may receive signaling 112 from remote unit 101 and forward the indications of signaling 112 to node 121 via signaling network 131 and network interface 127.

A brief summary that focuses on certain more detailed embodiments appears below to provide some additional and more particular examples. They are intended to further the reader's understanding of the variety of possible embodiments rather than to limit the scope of the invention.

Three components of dynamic interference relief are proposed to improve coverage and outage rates. Depending on the embodiment, these components may be incorporated individually, in part or in combination:
1. Feedback of a “Help NAK” (H-NAK) signal by the receiver to reach users, in the case of uplink (UL) transmissions, or base-stations, in the case of downlink (DL) transmissions, of other cells. This enables dynamic cooperative interference reduction when a user's packet is close to being in outage.
2. Other-cell transmission nulling and interference suppression based on beamforming for multiple antenna systems, referred to as Other-cell Beamformed Interference Suppression (OBIS). This enables spatial interference reduction per-beam in conjunction with the Help NAK signaling. It allows for spatial interference suppression at both transmit and receive ends (especially for equipment with multiple antennas).
3. Enable dynamic spatial reuse (not per-user) using the concept of H-NAK. The approach here is to have a dynamic interference management scheme that does partial spatial power shaping based on an overall metric of cell-edge loading, as opposed to a per-user/per-packet interference suppression. This aims to provide a spatial dimension to FFR with the power shaping depending on actual traffic conditions.

Static interference avoidance schemes like fractional frequency reuse rely on knowing in advance a good split of types of users (e.g., good/bad geometry, different traffic mixes) within a cell. This is not necessarily the best way to improve a cell-edge data rate or a voice outage rate. In H-NAK embodiments, minimal signaling is proposed over-the-air so that users are able to tell other base-stations to reduce their transmission power dynamically. Since this is done per-packet and is not sent very often, it has a small impact on scheduler resources, while having the potential to improve outage and cell-edge rate.

A second approach enhances the interference relief ideas for multiple antenna systems. Typically, multiple antenna systems are deployed to work without any inter-BS coordination. But because of the spatial dimensions available, it is desirable to have cooperative interference reduction with multi-antenna base-stations and terminals. This is achieved in the proposed scheme with low overhead and over-the-air signaling (on an “as-needed” basis).

In H-NAK embodiments, users that are about to abort on a packet (e.g., having reached the last transmission), send a special signal (perhaps a one bit signal), called the Help NAK to its nearest (or a set of strongest) interfering base-stations. The idea is for users that are about to experience an outage to get interference relief from their nearest interfering cells.

The H-NAK signal may be modulated with a sequence that conveys the resource blocks that are used for its transmission. Thus, the other base-stations can detect this signal and know that a given user needs interference relief on a particular resource block. There could be more than one user sending the same H-NAK signal from different cells. These will all be combined implicitly by a given base-station, using the idea of single-frequency-reuse. The strength of this combined signal gives an indication to the base-station as to how much to reduce its power in the next transmission on that particular resource block.

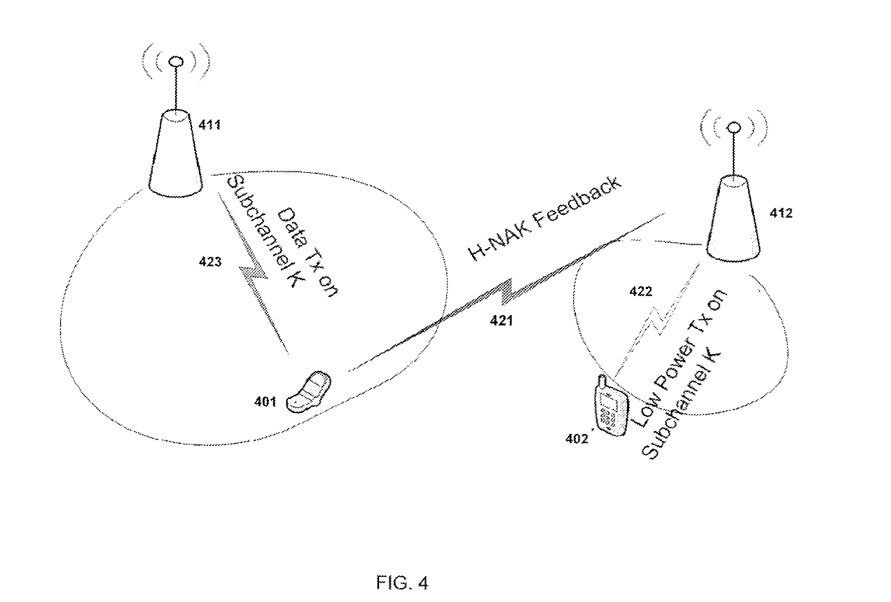

As depicted in FIG. 4, MS 401 at the cell-edge is communicating with BS 411 as its serving cell. MS 401 sends H-NAK signal 421 to its nearest interfering base-station, BS 412, which upon reception, dynamically reduces the power on those resource blocks in signal 422 at the next transmission interval. This allows MS 401 to receive signal 423 with less interference from BS 412.

By the same token, for UL transmissions, a base-station can broadcast an H-NAK signal corresponding the resource blocks where packets are likely to be aborted. Cell-edge users in other cells can detect this broadcast signal, and decide to autonomously power down their next transmission if they are using those indicated resource blocks.

Thus, a given receiver provides feedback in the form of a “Help NAK” (H-NAK) to reach users (for UL transmissions) or base-stations (for DL transmissions) of other cells. By doing so, dynamic cooperative interference reduction is enabled when a user's packet is close to being in outage.

For DL service, users transmit an H-NAK to reach other cells when the packet is about to fail. Depending on the embodiment, these other cells know the resource block allocation by the position/modulation of the H-NAK. If possible, other cells then mute or reduce transmit power spectral density on those requested resource blocks for the remaining duration of that packet's transmission. Depending on the embodiment, the power of an H-NAK signal may be boosted to reach the strongest interfering cell.

In H-NAK embodiments that apply these techniques to UL service, users in other cells monitor H-NAK signaling from a candidate set of cells. If they use the same sub-channel in which an H-NAK is observed, they will reduce the transmit PSD of their subsequent transmissions autonomously and to the extent possible. The transmit power of a broadcast H-NAK on the DL may need to be adapted to achieve a moderate penetration into the other cells.

A detailed description of some of the Other-cell Beamformed Interference Suppression (OBIS) embodiments follows. In some of these embodiments, when a base-station is equipped with multiple antennas, a user that needs interference relief will measure the optimal beam from a set of the strongest interfering cells and feed these beam weights back to the interfering base-stations along with the H-NAK. Knowing the beam that causes the maximum power to be directed to that user, the base can decide to allocate smaller power in the direction of that beam on the requested resource blocks. This allows the interfering base-station to not have to reduce the power unilaterally on that resource block, but rather, only over the spatial beam that results in maximum interference to the user that needs interference relief.

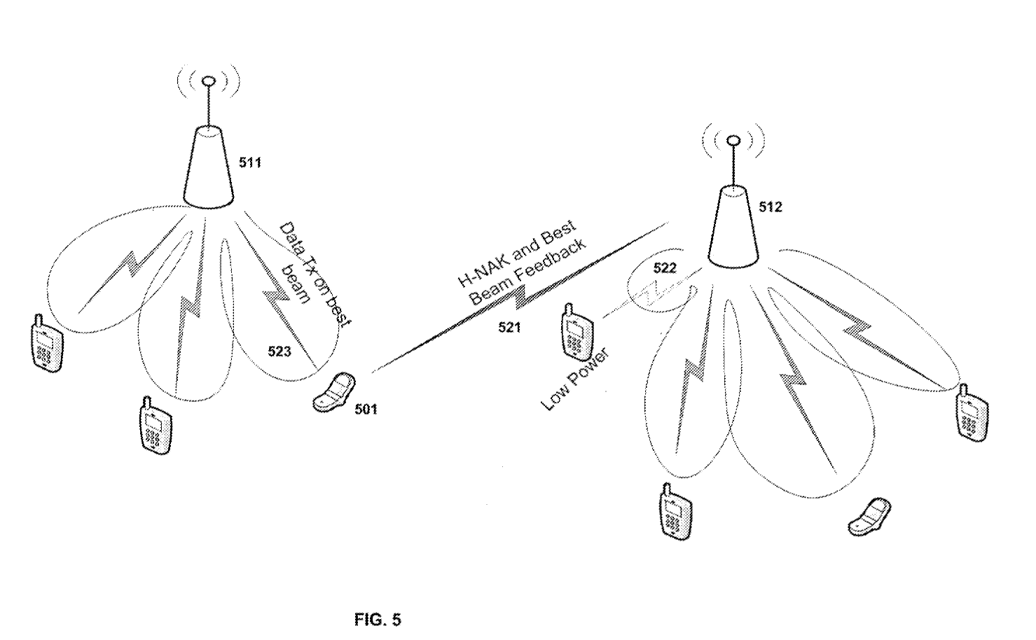

FIG. 5 illustrates some embodiments that apply these OBIS techniques to DL service. MS 501 at the cell-edge is communicating with BS 511 as its serving cell. MS 501 requests (521) its dominant interfering cell, BS 512, to transmit (on MS 501's resource blocks) with a spatial signature that reduces the interference seen from BS 512 to MS 501. Then MS 501 feeds back (521) an optimal spatial pre-coder (beam-former weights) to BS 512 that maximizes the signal energy MS 501 sees from the BS 512. The interfering BS 512 then transmits (522) low (or no) power in the direction indicated by the pre-coder feedback from MS 501. This allows MS 501 to receive signal 523 with less interference from BS 512.

The optimal pre-coder or beam-former weights change dynamically for diversity antennas and thus should be fed back dynamically. For correlated antennas, the beam can be known at BS 512 using long-term updates of the preferred beam index by MS 501 as the spatial beam pattern does not change very fast. This “most interfering beam” information may be sent along with the H-NAK feedback, or possibly in separate signaling. BS 512 then can use other spatial dimensions available to transmit to its users using SDMA (Spatial-Division Multiple Access).

In some of the embodiments that apply OBIS techniques to UL service, if the base uses correlated antennas, then it transmits the H-NAK using the best beam used for uplink reception of the user in outage. The other-cell users that receive this H-NAK are automatically the ones that cause the most interference on the uplink in that spatial direction. These users can then mute (or reduce) their transmit PSD (as described before). By using beamformed H-NAKs, a smaller fraction of users will need to reduce their PSD in comparison to the single-base-antenna H-NAK case, thus leading to spatial interference suppression. Further, users with multiple transmit antennas can, in time division duplex (TDD) systems, use the H-NAK based channel estimates to spatially null their uplink transmissions in the beam direction of the base transmitting the H-NAK. Thus, the OBIS approach enables spatial interference reduction per-beam in conjunction with “Help NAK” signaling and allows for spatial interference suppression both at the transmit and the receive ends.

In the above discussion, the general approach was to reduce the power spectral density of transmissions based on an H-NAK signal that receivers feed back in cases when they are about to experience an outage. This leads to a user-specific and packet-specific interference nulling/suppression scheme. Another approach is to devise an average spatial interference suppression that would be applicable for all users in all cells in order for cells to come up with non-uniform spatial power loading. The idea here is to feed back a signal like the H-NAK, but on a very slow basis, to indicate spatial interference conditions. Such an approach could enable dynamic fractional spatial reuse (FSR).

For example, for the DL, there could be an H-NAK signaling slot where all users that need interference relief would send an H-NAK signal, not specific to any resource allocation, but indicating the spatial beam (from a finite set of spatial beams that are pre-defined, e.g.) that each is seeing the most interference from. The base-station could then collect the H-NAK energies corresponding to each of these finite spatial beams and decide how to reduce the transmit power on those spatial beams. This approach may lead to a slow-adaptation of spatial interference patterns based on the actual interference experienced by the cell-edge users in other cells. The base-station could then transmit a smaller PSD on the beams that cause the most interference to users in neighboring cells, thereby possibly improving cell-edge data rates.

One of skill in the art will appreciate that various modifications and changes may be made to the specific embodiments described above with respect to FIGS. 4 and 5 without departing from the spirit and scope of the present invention. Thus, the discussion of certain embodiments in greater detail above is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the information or object being indicated. Some, but not all examples of techniques available for communicating or referencing the information or object being indicated include the conveyance of the information or object being indicated, the conveyance of an identifier of the information or object being indicated, the conveyance of information used to generate the information or object being indicated, the conveyance of some part or portion of the information or object being indicated, the conveyance of some derivation of the information or object being indicated, the conveyance of some symbol representing the information or object being indicated, and the manner of, form of, type of, location of, relative location of, placement of, timing of or other characteristic or attribute of the conveyance itself. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method to facilitate dynamic cooperative interference reduction comprising:
receiving, by a first communication device, receive signaling from a source communication device;
transmitting, by the first communication device, signaling indicating that the first communication device is requesting an interfering communication device to reduce transmissions that may be interfering with signaling from the source communication device.

2. The method of claim 1,
wherein the receive signaling comprises a packet that has not been successfully received and
wherein transmitting the signaling indicating that the first communication device is requesting the interfering communication device to reduce transmissions comprises transmitting the signaling after a threshold number unsuccessful retransmissions.

3. The method of claim 2, wherein the threshold number unsuccessful retransmissions comprise a threshold number of HARQ (hybrid automatic retransmission request) retransmissions.

4. The method of claim 1, wherein transmitting the signaling indicating that the first communication device is requesting the interfering communication device to reduce transmissions comprises
transmitting the signaling to indicate at least one of a resource block, a sub-channel, a beam and a duration for which reduced transmission is requested.

5. The method of claim 1, further comprising
transmitting, by the first communication device to the interfering communication device, signaling indicating an optimal spatial pre-coder that maximizes the signal energy at the first communication device from the interfering communication device.

6. The method of claim 1,
wherein the first communication device comprises a remote unit,
wherein the source communication device comprises a network node and
wherein the interfering communication device comprises an interfering network node.

7. The method of claim 1,
wherein the first communication device comprises a network node,
wherein the source communication device comprises a remote unit and
wherein the interfering communication device comprises an interfering remote unit.

8. A method to facilitate dynamic cooperative interference reduction comprising:
receiving, by an interfering communication device, signaling indicating that a first communication device is requesting the interfering communication device to reduce transmissions that may be interfering with signaling for the first communication device from a source communication device;
reducing transmissions, by the interfering communication device, based at least in part on what was indicated by the received signaling.

9. The method of claim 8, wherein reducing transmissions comprises at least one of reducing transmit power, reducing transmit power spectral density (PSD) and muting transmit power.

10. The method of claim 8, wherein reducing transmissions comprises reducing transmissions as indicated by the received signaling for at least one of an indicated resource block, an indicated sub-channel, an indicated beam and an indicated duration.

11. The method of claim 8, further comprising
receiving, by an interfering communication device from the first communication device, signaling indicating an optimal spatial pre-coder that maximizes the signal energy at the first communication device from the interfering communication device, and
wherein reducing transmissions comprises reducing transmissions in the direction indicated by the optimal spatial pre-coder.

12. The method of claim 8,
wherein the first communication device comprises a remote unit,
wherein the source communication device comprises a network node and
wherein the interfering communication device comprises an interfering network node.

13. The method of claim 8,
wherein the first communication device comprises a network node,
wherein the source communication device comprises a remote unit and
wherein the interfering communication device comprises an interfering remote unit.

14. A communication device for facilitating dynamic cooperative interference reduction, the communication device comprising:
a transceiver;
a processing unit, communicatively coupled to the transceiver,
adapted to receive, via the transceiver, receive signaling from a source communication device, and
adapted to transmit, via the transceiver, signaling indicating that the communication device is requesting an interfering communication device to reduce transmissions that may be interfering with signaling from the source communication device.

15. The communication device of claim 14,
wherein the receive signaling comprises a packet that has not been successfully received and
wherein being adapted to transmit the signaling indicating that the communication device is requesting the interfering communication device to reduce transmissions comprises being adapted to transmit the signaling after a threshold number unsuccessful retransmissions.

16. The communication device of claim 15, wherein the threshold number unsuccessful retransmissions comprise a threshold number of HARQ (hybrid automatic retransmission request) retransmissions.

17. The communication device of claim 14, wherein being adapted to transmit the signaling indicating that the communication device is requesting the interfering communication device to reduce transmissions comprises being
adapted to transmit the signaling to indicate at least one of a resource block, a sub-channel, a beam and a duration for which reduced transmission is requested.

18. A communication device for facilitating dynamic cooperative interference reduction, the communication device comprising:
a transceiver;
a processing unit, communicatively coupled to the transceiver,
adapted to receive, via the transceiver, signaling indicating that a first communication device is requesting the communication device to reduce transmissions that may be interfering with signaling for the first communication device from a source communication device, and
adapted to reduce transmissions, via the transceiver, based at least in part on what was indicated by the received signaling.

19. The communication device of claim 18, wherein being adapted to reduce transmissions comprises being adapted to reduce at least one of transmit power and transmit power spectral density (PSD).

20. The communication device of claim 18, wherein being adapted to reduce transmissions comprises being adapted to reduce transmissions as indicated by the received signaling for at least one of an indicated resource block, an indicated sub-channel, an indicated beam and an indicated duration.
